(19) United States
(12) Patent Application Publication
(10) Pub. No.: US 2015/0201655 A1
(43) Pub. Date: Jul. 23, 2015

(54) Oil And Fat Replacing Purees

(71) Applicant: Pro Brands, LLC, Orange Park, FL (US)

(72) Inventors: Thomas Rykalsky, Orange Park, FL (US); Michael Zimmerman, Euless, TX (US)

(73) Assignee: PRO BRANDS, LLC, Orange Park, FL (US)

(21) Appl. No.: 14/598,631

(22) Filed: Jan. 16, 2015

Related U.S. Application Data
(60) Provisional application No. 61/928,613, filed on Jan. 17, 2014.

(51) Int. Cl. A23L 1/212

(52) U.S. Cl. CPC A23L 1/2128; A23V 2002/00

(57) ABSTRACT

Mixes, compositions, foodstuffs, and other consumables are disclosed which replace oil, shortening, butter and other fats, as well as sugar, with vegetable puree. In an aspect, a food preparation, namely a baked good, is disclosed comprising pumpkin puree and an effective amount of natural vegetable or fruit sweetener. In an aspect, the puree composition is chosen to supply one serving of vegetables per food preparation serving (e.g., one muffin). The puree composition replaces up to 100 percent of the fats and up to 100 percent of the added sugar utilized to otherwise prepare the food preparations.

### CROSS REFERENCE TO RELATED APPLICATION

This application claims the benefit of U.S. Provisional Patent Application No. 61/928,613, filed Jan. 17, 2014, and entitled “Oil and Fat Replacing Purees”, the entire contents of which is incorporated herein by reference.

### FIELD OF THE DISCLOSURE

The present disclosure relates to food production and more particularly to fat and sugar replacements.

### BACKGROUND

The statements in this section merely provide background information related to the present disclosure and may not constitute prior art.

The USDA recommends that individuals consume two to four servings of fruit and three to five servings of vegetables daily. Research indicates that, among other benefits, individuals who eat more fruits and vegetables have lower body mass indices, live longer and have a reduced risk of heart disease, decreased bone loss due to aging, and avoid type 2 diabetes. Despite the myriad health benefits and USDA recommendations, according to the CDC Americans consumed 1.1 servings of fruit and 1.6 servings of vegetables per day in 2013; less than 60% of the recommended minimum. Furthermore, adolescents and children consumed even fewer fruits and vegetables, only 1 fruit serving and 1.3 vegetable servings on average. Most vegetables consumed by adolescents and children came in the form of fried foods, such as French fries or potato chips.

Efforts have been made to encourage the public to consume more fruits and vegetables. For example, the USDA has implemented a Fresh Fruit and Vegetable Program which educates children about the benefits of fruits and vegetables and makes fruit and vegetable snacks available at no cost to children in participating schools. Many educational programs exist which encourage individuals to consume a more balanced, healthy diet, including the 5 A Day program. Starting in the early 2000s, the 5 A Day program has been enacted in the United States, the United Kingdom, Germany and other countries in order to encourage individuals to consume at least five servings of fruits and vegetables a day.

The Western pattern diet is a significant barrier to increased consumption of fruits and vegetables. The Western pattern diet, also known as the “Standard American Diet,” (SAD) is characterized by high intakes of red meat, sugary dessert, high-fat foods, and refined grains. Typically, the SAD comprises 35% or more of fat, well over the recommended amount. Many Americans find that the high sugar, high fat content of the Standard American Diet is very flavorful and filling, compared to consuming fruits and vegetables, therefore they are unwilling to switch to a healthier diet.

Given the foregoing, food products are needed which reduce or replace fat and sugar content in food stuffs while remaining enjoyable to consume.

The foregoing examples of the related art and limitations related thereto are intended to be illustrative and not exclusive. Other limitations of the related art will become apparent to those of skill in the art upon a reading of the specification.

### SUMMARY

This Summary is provided to introduce a selection of concepts in a simplified form that are further described below in the Detailed Description. This Summary is not intended to identify key features or essential features of the subject matter, nor is this Summary intended as an aid in determining the scope of the disclosed subject matter.

Aspects of the present disclosure meet the above-identified needs by providing compositions, mixtures, and methods for reducing or replacing some or all of the fat and/or sugar in food stuffs. The compositions, mixtures, and methods of the present disclosure are useful for a variety of purposes and in a variety of enterprises, such as restaurants, home cooks, commercial food production, school lunch programs and the like.

This disclosure addresses the above-described situation by providing food ingredients, food compositions, other foodstuffs, and food preparations which comprise a puree composition of vegetables and/or fruits. The puree composition is chosen to replace some or all of the oils, shortening, butter and other fats and/or sugars within a food preparation. The puree composition may provide a serving of fruits and/or vegetables.

In an aspect, a puree composition is disclosed which serves as fat and/or sugar replacement in baked goods. In an aspect, the puree composition is used in the production of a food preparation, such as a brownie, pizza crust, cookie, or muffin. The puree composition comprises fruits and/or vegetables. The puree composition may further comprise an effective amount of sweetener. In some aspects, the puree composition consists only of fruits and/or vegetables and provides the desired amount of sweetness from the natural characteristics of the included fruits and/or vegetables. The puree composition provides a texture, taste, and moisture content similar to a traditional food preparation.

Puree compositions in accordance with the present disclosure may comprise one or more fruits and vegetables such as broccoli, spinach, kale, cauliflower, pumpkin, squash, carrot, sweet potato, blueberry, strawberry, or a combination thereof. Such puree compositions may be used to replace up to 100 percent of the fats and up to 100 percent of the added sugar utilized to otherwise prepare the food preparations.

In some aspects, a baked good is produced and molecules of the puree compositions adhere to grain molecules during the cooking process in order to provide a moisture barrier that helps retain the moisture, nutrients and consistency of the baked good.

Further features and advantages of the compositions, mixtures, and methods disclosed herein, as well as the structure and operation of various aspects of the present disclosure, are described in detail below.

### DETAILED DESCRIPTION

Throughout the following description, specific details are set forth in order to provide a more thorough understanding to persons skilled in the relevant art(s). However, well-known elements may not be shown or described in detail to avoid unnecessarily obscuring the disclosure. Accordingly, the description is to be regarded in an illustrative, rather than a restrictive, sense.

As used herein, the term “fat” is used to mean any of the sources of dietary fat in a given food. In an aspect, “fat” includes both plant- and animal-based sources and also includes man-made sources of fat used in food. In an aspect, the term “fat” includes oil, shortening, butter, margarine, and other similar terms which represent sources of dietary fat in foods. In an aspect, the term “fat” includes any or all of the types of fats typically found in foods, such as monounsaturated fats, polyunsaturated fats, saturated fats and trans fats, as those terms are known in the relevant art(s).

In an aspect, as used herein, the term “sugar” is used to mean any of the sources of sugars in a given food. In an aspect, “sugar” includes natural sugars and processed sugars and derivatives such as corn syrup and sugar alcohols.

In an aspect, the puree composition disclosed herein is used to replace some or all of the fat in a given food preparation. In an aspect, the puree composition disclosed herein is used to replace some or all of the sugar in a given food preparation. In an aspect, the puree composition disclosed herein is used so that the amount of fat present in a given food preparation is reduced as compared to the food preparation without the use of the puree composition. In an aspect, the puree composition disclosed herein is used so that the amount of sugar present in a given food preparation is reduced as compared to the food preparation without the use of the puree composition.

In an aspect, as used herein, the terms “food”, “food preparation”, “food ingredient”, “food product”, “food composition”, “other foodstuffs”, and similar terms are intended to be broadly defined and mean any portion or aspect of the preparation of a food for consumption or the food itself. For example, the terms may mean a combination of ingredients used to prepare a food product, the final product, and any other aspect, as will be understood by a person of ordinary skill in the relevant art(s) upon reading the disclosure.

In an aspect, the amount of fat and/or sugar in a given food that is replaced by the puree composition as disclosed herein is chosen to make a food which has a desired characteristic, such as a percentage of fat reduction; a percentage of sugar reduction; a particular calorie count or calorie range in a serving size; a number of servings or partial servings of fruit or vegetable in a serving size; an amount of vitamins or minerals in a serving size; or other characteristics, as understood by a person having ordinary skill in the relevant art(s).

As used herein, “puree” takes its meaning as is conventional in the relevant art(s), unless otherwise specified. As used herein, a fruit or vegetable “puree” means a physically or chemically modified fruit or vegetable where the average particle size is smaller than in the non-pureed ingredient. The average particle size of the puree composition or each component in the puree composition can be selected so that the resulting food product has a desired taste or texture, or other characteristic. As used herein, a “puree composition” comprises one or more components comprising pureed fruits and/or vegetables and can be prepared using any method, such as, but not limited to, mashing or processing using a food processor or other similar device, passing through a sieve, grinding, chopping, cutting, blending, extruding, or other means known in the relevant art(s). A puree composition can be derived from fruit or vegetable materials that contain moisture. A puree composition can be a paste or thick suspension made from ground fruit or vegetable. A puree composition can contain water or other liquids. A puree composition can be concentrated by removing water or liquid.

In some aspects, a food product is produced and molecules of the puree compositions adhere to grain molecules during the cooking process in order to provide a moisture barrier that helps retain the moisture, nutrients and consistency of the food product.

In an aspect, the components of the puree composition disclosed herein are separately pureed. In an aspect, the components of the puree composition disclosed herein are pureed together.

In an aspect, an effective amount of food preservative is added to the puree composition so that the puree composition is more stable or otherwise has improved storage properties. The identity and use of food preservatives is known to one having ordinary skill in the relevant art(s). In an aspect, the puree composition is treated to kill microorganisms that can be harmful to humans and animals. In an aspect, the puree composition is heat treated or treated with ultraviolet light. These treatments can be useful to provide an extended shelf life of the puree composition and also for food safety reasons. The identity and use of treatments such as heat and ultraviolet light is known to one having ordinary skill in the relevant art(s).

In an aspect, the puree composition can be used as an ingredient in food for humans. In an aspect, the puree composition can be used as an ingredient in food for animals. In an aspect, the puree composition can be used as an ingredient in food marketed to specific demographic groups, such as children, adolescents, adults, senior citizens, and other groups.

The present disclosure is directed to food ingredients, food compositions, other foodstuffs, and food preparations which comprise a puree composition of vegetables and/or fruits. The puree composition is chosen to replace oils, shortening, butter and other fats and/or sugars within a food preparation (e.g., a muffin, pizza dough, a cookie, a smoothie, a frozen drink, a grain-based food preparation, and the like) and provide a serving or partial serving of fruits and/or vegetables. In some aspects, the puree composition is configured to maintain the taste profile, water content, structure, and other qualities of a food preparation produced in a traditional, high-fat, high-sugar manner, thereby greatly increasing the likelihood that the food preparation will be consumed and enjoyed by individuals used to high fat content food preparations. The parameters used to measure taste profile, water content, structure, and other qualities of a food preparation are known to a person of ordinary skill in the relevant art(s) and the maintenance of those parameters in a product made using the puree composition of the present disclosure are known to a person of ordinary skill in the relevant art(s). In this way, enjoyable food preparations are created which provide increased nutritional value and reduce consumption of fats and/or sugars.

Broadly, aspects of the present disclosure comprise a vegetable and/or fruit puree and optional effective amounts of sweetener configured to be mixed with one or more additional ingredients to create a food preparation (e.g., a baked good, a brownie, a muffin, a breakfast bar, pizza dough, and the like). Puree compositions in accordance with aspects of the present disclosure replace up to 100 percent of the fat utilized to otherwise prepare the food preparations. Puree compositions in accordance with aspects of the present disclosure replace up to 100 percent of the added sugar used to otherwise prepare the food preparations. Some aspects of the present disclosure are adapted to maintain an appealing texture, appearance, and taste of the food preparation, thereby providing a serving or a partial serving of fruits and/or vegetables in a food preparation that does not typically contain significant amounts of fruits and/or vegetables. In an aspect, a puree composition of the present disclosure effectively replaces up to 100 percent of the fat utilized and up to 100 percent of the added sugar in a food preparation, whereas simply adding chopped or whole vegetables or fruits is ineffective. In an aspect, a puree composition of the present disclosure replaces from 60-99% of the fats in a given food product. In an aspect, a puree composition of the present invention replaces up to 50% of the sugar in a given food product.

In an aspect, a puree composition comprises a puree of fruits and/or vegetables and a sweetener. The sweetener can be any suitable natural or artificial sweetener, or a combination thereof, as known to a person of ordinary skill in the relevant art(s). In some aspects, the sweetener is omitted. In some aspects, the puree composition consists only of fruits and/or vegetables and provides the desired amount of sweetness from the natural characteristics of the included fruits and/or vegetables.

In an aspect, the puree composition is a puree of one or more fruits or vegetables including, but not limited to, broccoli, spinach, kale, cauliflower, pumpkin, squash, carrot, sweet potato, blueberry, and strawberry. In an aspect, the puree composition is a puree of one or more fruits or vegetables including, but not limited to, broccoli, spinach, kale, cauliflower, pumpkin, squash, carrot, and sweet potato. In an aspect, the puree composition is a puree of one or more fruits or vegetables that are green in their natural state. In an aspect, the puree composition is a puree of one or more fruits or vegetables that are orange in their natural state.

In various aspects, the puree composition comprises multiple fruits and vegetables at various percentages in the total puree composition. In an aspect, the puree composition contains from at least 10% and up to 90% by weight of each component. In an aspect, the puree composition contains multiple fruits and vegetables at weight ratios between 1:1 and 1:10. In various aspects, the puree composition comprises multiple fruits and vegetables at ratios between 1:1 and 1:3 by weight. In other aspects, the puree composition is comprised of fifty percent by weight of one fruit or vegetable (e.g., pumpkin) and various amounts of other fruits, vegetables, tubers, and the like. In other aspects, the puree composition is comprised of not more than fifty percent by weight of one fruit or vegetable (e.g., pumpkin) and various amounts of other fruits, vegetables, tubers, and the like.

The puree composition in accordance with the present disclosure is not necessarily a homogenized mixture of the various components. In other words, in a particular food preparation, each component in the puree composition can be added or incorporated separately in the preparation of food and the overall food will still contain a puree composition of the present disclosure. In certain aspects, it may be desirable to have a pre-formed puree composition that can be added in the food preparation. In other aspects, it may be desirable to incorporate each component separately in the food preparation. All of these aspects are intended to be included in the present disclosure.

Puree compositions in accordance with the present disclosure are suitable for mixing with grains for production of baked goods and other food preparations. Puree compositions in accordance with the present disclosure are suitable for mixing with other liquid or semi-solid ingredients for production of baked goods and other food preparations.

In another aspect, a puree composition in accordance with the present disclosure is utilized to replace some or all of the added sugar content in a liquid, such as a slushy or frozen beverage. In yet another aspect, a puree composition in accordance with the present disclosure is utilized in a smoothie, an ice cream, a fried food preparation, or another food preparation apparent to those skilled in the relevant art(s) after reading the description herein.

As used herein, “fruit” and “vegetable” take their meaning as is conventional in the relevant art(s). It is recognized that the technical scientific definition of “fruit” and “vegetable” is sometimes not the same as is commonly understood by the ordinary person. For example, pumpkin is commonly thought of as a vegetable, however, it is a fruit in the botanical sense. As used herein, the terms “fruit” and “vegetable” are intended to be broad enough to encompass both the technical scientific definition and the common meaning. In some aspects, the combined term “fruits and vegetables” is intended to mean the collective set of all fruits and vegetables, without specifying if a certain component is technically a fruit or a vegetable. Therefore, for example, if a particular puree composition contains two members of the group “fruits and vegetables”, the members can be two fruits, two vegetables, or one fruit and one vegetable.

In an aspect, provided is a puree composition comprising two or more components selected from fruits and vegetables. In an aspect, each component is present in the puree composition in a percentage of 10% by weight up to 90% by weight of the puree composition. In an aspect, each component is present in the puree composition at weight ratios of between 1:1 and 1:3. In an aspect, each component is at most fifty percent by weight of the puree composition.

In an aspect, the puree composition components are two or more of Boysenberry, Pineapple, blackberry, apricot, apple, asparagus, corn, green bean, bell pepper, rhubarb, cranberry, raspberry pear, broccoli, spinach, kale, cauliflower, pumpkin, squash, carrot, sweet potato, blueberry, and strawberry. In an aspect, the puree composition components are two or more of broccoli, spinach, kale, cauliflower, pumpkin, squash, carrot, and sweet potato. In an aspect, the puree composition components are two or more of broccoli, spinach, kale, pumpkin, squash, and carrot. In an aspect, the puree composition components are two or more of spinach, pumpkin and carrot. In an aspect, the puree composition components are pumpkin and carrot, and the pumpkin is present in the puree composition at a weight percentage of between 10% by weight at 20% by weight.

In an aspect, the puree composition components are pumpkin and spinach. In an aspect where the puree components are pumpkin and spinach, the pumpkin is present in the puree composition at a weight percentage of between 50% by weight at 70% by weight. In an aspect where the puree components are pumpkin and spinach, the pumpkin is present in the puree composition at a weight percentage of between 10% by weight at 20% by weight.

In an aspect, the components of the puree composition are selected from green fruits and vegetables. In an aspect, the components of the puree composition are two or more of broccoli, spinach and kale. In an aspect, the components of the puree composition are selected from orange fruits and vegetables. In an aspect, the components of the puree composition are two or more of pumpkin, carrot, squash and sweet potato (yam).

In an aspect, the puree composition further comprises a sweetener. In aspects where the puree composition further comprises a sweetener, the sweetener can be a natural or artificial sweetener, or combination thereof. In aspects where the puree composition further comprises a sweetener, the sweetener can be a fruit or vegetable.

Also provided is a food product with a reduced fat or sugar content, the food product made by replacing some fat-containing or sugar-containing ingredients in the food product with a puree composition, the puree composition comprising a puree of two or more components selected from fruits and vegetables, wherein each component is present in the puree composition in a percentage of 10% by weight up to 90% by weight of the puree composition. The puree composition disclosed herein can replace all or a portion of the fat present in a food product. The puree composition disclosed herein can replace all or a portion of the sugar present in a food product. The puree composition disclosed herein can replace all or a portion of the fat and sugar present in a food product. In aspects, the puree composition disclosed herein replaces at least half of the fat in a food product. In aspects, the puree composition disclosed herein replaces at least half of the sugar in a food product. In aspects, the puree composition disclosed herein replaces at least 25% of the fat in a food product. In aspects, the puree composition disclosed herein replaces at least 25% of the sugar in a food product. In aspects, the puree composition disclosed herein replaces at least 75% of the fat in a food product. In aspects, the puree composition disclosed herein replaces at least 75% of the sugar in a food product.

In an aspect, the food product made with the puree composition disclosed herein is a baked good. In an aspect, the food product made with the puree composition disclosed herein a brownie, muffin, pizza dough, cookie or bread.

In an aspect, the food product made with the puree composition disclosed herein is a liquid. In an aspect, the food product made with the puree composition disclosed herein is a beverage. In an aspect, the food product made with the puree composition disclosed herein is semi-frozen or frozen. In an aspect, the food product made with the puree composition disclosed herein is a semi-frozen or frozen beverage, where at least a portion of the sugar in the food product is replaced with the puree composition disclosed herein.

Also provided is a method of making a puree composition, the method comprising the steps of: (a) choosing two or more components, the components comprising fruits and vegetables; (b) reducing the particle size of the components to form a puree composition. The particle size can be reduced by methods known in the art and disclosed elsewhere herein. The liquid content of the puree composition can also be adjusted to a desired value, either for ease of incorporating the puree composition in the food product, for storage reasons or other reasons known to a person of ordinary skill in the art. The liquid content of the puree composition can be adjusted by concentrating the puree composition, boiling off some liquid, or other means known to a person having ordinary skill in the relevant art(s). The particle size of the components in the puree composition can affect the characteristics of the food product made using the puree composition, as understood by a person having ordinary skill in the relevant art(s). The particle size of the puree composition can be adjusted as desired and as known to a person having ordinary skill in the relevant art(s).

### Examples

In an aspect, a traditional oil- and fat-based recipe for a food preparation (e.g., pizza dough) is analyzed. Puree compositions of the present disclosure are used to replace the fat content within the recipe with useful amounts of the puree composition, thereby providing vegetable servings while maintaining the taste, texture, and other desirable qualities of the recipe. The food preparation may then be prepared utilizing the recipe comprising the puree composition. Exemplary recipes follow.

In an aspect, a traditional pizza dough recipe (Table 1) is altered by incorporating a puree composition of the present disclosure. The puree composition comprises pumpkin puree and an effective amount of sweetener. The sweetener may be an artificial, low-calorie sweetener, an artificial zero-calorie sweetener, vegetable-based sweeteners, tuber-based sweeteners, fruit-based sweeteners, or any combination thereof.

TABLE 1
Oil-based Pizza Dough

| Ingredient | Weight | Measure |
|---|---|---|
| Whole Wheat Flour | 3 lbs. 8 oz. | 3 qt 1 cup |
| Salt | | 1½ tsp |
| Sugar | | 2 Tsp |
| Active dry yeast | | 2 Tbsp 1½ tsp |
| Water, warm (130 degrees F.) | | 1 qt ¼ cup |
| Vegetable oil | | ⅓ cup |
| Cornmeal | 2½ oz. | ½ cup 2 Tbsp |

The puree composition-based recipe, shown in Table 2, below, modifies the oil-based pizza dough recipe of Table 1. One serving of crust using the recipe of Table 2 provides one serving of vegetables, which maintaining a desirable texture and flavor. The below recipe provides fifty servings.

TABLE 2
Puree Composition-based Pizza Dough

| Ingredient | Weight | Measure |
|---|---|---|
| Whole Wheat Flour | 3 lbs. 8 oz. | 3 qt 1 cup |
| Salt | | 1½ tsp |
| Sugar | | 1 Tsp |
| Active dry yeast | | 2 Tbsp 1½ tsp |
| Water, warm (130 degrees F.) | | 0 cups |
| Vegetable oil | | 0 cups |
| Cornmeal | 2½ oz. | ½ cup 2 Tbsp |
| Puree Composition | 50 oz. | |

As shown in Table 3, below, the puree composition-based pizza has a much more significant nutritional value.

TABLE 3
Comparison of Nutrients per Serving

| | W/ Puree | | W/O Puree | |
|---|---|---|---|---|
| Calories | 115 | | 130 | |
| Protein | 4 | g | 4 | g |
| Carbohydrate | 24 | g | 26.11 | g |
| Total Fat | 1 | g | 1.3 | g |
| Saturated Fat | 0 | g | 0.26 | g |
| Cholesterol | 0 | mg | 0 | mg |
| Vitamin A | 600 | IU | 3 | IU |
| Vitamin C | 7.5 | mg | 0 | mg |
| Iron | 10.5 | mg | 9 | mg |
| Calcium | 12 | mg | 6 | mg |
| Sodium | 71 | mg | 71 | mg |
| Dietary Fiber | 3.5 | g | 3 | g |

In another aspect, a brownie is produced utilizing a puree composition comprising spinach and pumpkin. An exemplary recipe is detailed in Table 4 which yields one hundred 1.5 ounce brownies, each containing a half serving of vegetables.

TABLE 4
Puree Composition-based Brownie

| Ingredient | Measure |
|---|---|
| Pumpkin Puree | 30 oz. |
| Spinach Puree | 20 oz. |
| Sugar | 3 lbs. 3 oz. |
| Salt | 1 Tbsp. |
| Vanilla | 1 Tbsp. |
| Whole eggs | 1 lb. 8 oz. |
| Enriched Flour | 14 oz. |
| Whole Wheat Flour | 1 lb. |
| Cocoa | 12 oz. |
| Baking Powder | 2 Tbsp. |

In another aspect, a different brownie is produced utilizing a puree composition comprising spinach and pumpkin. An exemplary recipe is detailed in Table 5.

TABLE 5
Puree Composition-spinach based Brownie

| Ingredient | Measure |
|---|---|
| Pumpkin Puree | ½ cup |
| Spinach Puree | 3 cups + 1 oz. |
| Sugar | 1 lb. + 10 oz. |
| Salt | 1½ tsp |
| Egg whites | 12 oz. |
| All purpose Flour | 7 oz. |
| Whole Grain | 8 oz. |
| Cocoa | 6 oz. |
| Baking Powder | 1 Tbsp. |

In another aspect, a coco muffin is produced using a puree composition of green vegetables. In an aspect, each muffin contains a half cup of green vegetables. In an aspect, broccoli, spinach and kale are used as the components in the puree composition. Coco muffins made with the vegetable puree were found to have lower calories, lower carbohydrates, lower fat and lower sugar than other commercial chocolate muffins. In addition, Table 6 shows the nutritional value of a coco muffin made with the puree composition.

TABLE 6
Nutrients per Serving Coco Muffin

| | W/ Puree | |
|---|---|---|
| Calories | 120 | |
| Protein | 3 | g |
| Carbohydrate | 23 | g |
| Total Fat | 2.5 | g |
| Saturated Fat | 1 | g |
| Cholesterol | 35 | mg |
| Vitamin A | 25% | DV |
| Vitamin C | 2% | DV |
| Iron | 8% | DV |
| Calcium | 2% | DV |
| Sodium | 190 | mg |
| Dietary Fiber | 2 | g |

In another aspect, a breakfast bar is produced utilizing a puree composition comprising carrot and pumpkin. An exemplary recipe is detailed in Table 7 which yields fifty 3.6 ounce bars.

TABLE 7
Puree Composition-based Breakfast Bar

| Ingredient | Measure |
|---|---|
| All Purpose Flour | 1 lb. 8 oz. |
| Whole Wheat | 2 lbs. |
| Nonfat Dry Milk | 3 oz. |
| Sugar | 14 oz. |
| Salt | 1 Tbsp. 1 tsp. |
| Raisins | 35 oz. |
| Dried Cranberries | 15 oz. |
| Whole Eggs | 10.5 oz. |
| Carrot Puree | 50 oz. |
| Pumpkin Puree | 8 oz. |

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

The present disclosure is sufficiently flexible and configurable, such that it may be implemented in ways other than that shown in the included tables. As will be appreciated by those skilled in the relevant art(s) after reading the description herein, certain features from the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A puree composition comprising two or more components selected from fruits and vegetables, wherein each component is present in the puree composition in a percentage of 10% by weight up to 90% by weight of the puree composition.

2. The puree composition of claim 1, wherein each component is present in the puree composition at weight ratios of between 1:1 and 1:3.

3. The puree composition of claim 1, wherein each component is at most fifty percent by weight of the puree composition.

4. The puree composition of claim 1, wherein in the puree composition the components are two or more of broccoli, spinach, kale, cauliflower, pumpkin, squash, carrot, sweet potato, blueberry, and strawberry.

5. The puree composition of claim 1, further comprising a sweetener.

6. The puree composition of claim 5, wherein the sweetener is a natural or artificial sweetener.

7. The puree composition of claim 5, wherein the sweetener is a fruit or vegetable.

8. The puree composition of claim 1, wherein the components are selected from pumpkin, carrot and spinach.

9. The puree composition of claim 8, wherein the components are pumpkin and carrot, and wherein the pumpkin is present in the puree composition at a weight percentage of between 10% by weight to 20% by weight.

10. The puree composition of claim 8, wherein the components are pumpkin and spinach, where the pumpkin is present in the puree composition at a weight percentage of between 50% by weight to 70% by weight.

11. The puree composition of claim 8, wherein the components are pumpkin and spinach, where the pumpkin is present in the puree composition at a weight percentage of between 10% by weight to 20% by weight.

12. The puree composition of claim 1, wherein the components are selected from green fruits and vegetables.

13. The puree composition of claim 12, wherein the components are two or more of broccoli, spinach and kale.

14. A food product with a reduced fat or sugar content, the food product made by replacing some fat-containing or sugar-containing ingredients in the food product with a puree composition, the puree composition comprising a puree of two or more components selected from fruits and vegetables, wherein each component is present in the puree composition in a percentage of 10% by weight up to 90% by weight of the puree composition.

15. The food product of claim 14, wherein the food product is a baked good.

16. The food product of claim 14, wherein the food product is a liquid.

17. The food product of claim 14, wherein the food product is semi-frozen or frozen.

18. The food product of claim 14, wherein the food product is a brownie, muffin, pizza dough, cookie or bread.

19. A method of making a puree composition, the method comprising the steps of:
(a) choosing two or more components, the components comprising fruits and vegetables;
(b) reducing the particle size of the components to form a puree composition.

20. The method of claim 19, further comprising adjusting the liquid content of the puree composition to the desired amount.
